(19) United States
(12) Patent Application Publication
(10) Pub. No.: US 2015/0012822 A1
(43) Pub. Date: Jan. 8, 2015

(54) METHOD AND APPARATUS FOR PROVIDING MEDIA ASSET RECOMMENDATIONS

(71) Applicant: TECHNICOLOR USA, INC., Indianapolis, IN (US)

(72) Inventors: Noah Dijulio, Portland, OR (US); Greg Martin, Portland, OR (US); Robert Nero, Portland, OR (US); Saran Osborn, Portland, OR (US); Roger Yeh, San Marino, CA (US)

(73) Assignee: THOMSON LICENSING, Issy de Moulineaux (FR)

(21) Appl. No.: 14/369,986

(22) PCT Filed: Jan. 8, 2013
(86) PCT No.: PCT/US13/20682

§ 371 Date: Jun. 30, 2014

Related U.S. Application Data
(60) Provisional application No. 61/584,307, filed on Jan. 8, 2012.

(51) Int. Cl. G06F 3/0484; H04L 29/08; G06F 3/0481

(52) U.S. Cl. CPC G06F 3/04842; G06F 3/0481; H04L 67/306
USPC 715/716

(57) ABSTRACT

The present disclosure is directed towards receiving media asset recommendations for one or more users according to user profile information. A user interface can be manipulated to selected user representations and have such representations placed in different zones (305, 310, 315, 320). Based on the representations selected, corresponding user profile data that corresponds to the selected user representations can be used to acquire media asset recommendations for the one or more users that were selected. The media asset recommendations can be displayed in a recommendation area (330) as pictures, video, and/or poster art, of the recommended media assets.

### CROSS REFERENCE TO RELATED APPLICATIONS

This application claims the benefit of U.S. Provisional Application Ser. No. 61/584,307 filed Jan. 8, 2012 which is incorporated by reference herein in its entirety.

### FIELD OF THE INVENTION

The present disclosure generally relates to media asset recommendations, and more specifically to generating media asset recommendations for a group of users using corresponding user profile information.

### BACKGROUND OF THE INVENTION

When a user is interested in watching a movie or a television show, as a form of a media asset, the user may want to receive recommendations about media assets that the user does not know anything about. Some systems provide a user with recommendations that are based on user profile information associated with the user based on the person's prior consumption of such assets. A difficultly can arise if the user wants to consume a media asset with a second person, at the same time, where the prior systems typically accommodate media asset suggestions for only one person. Hence, the suggestions for media assets would only pertain to the user or the second person, but not both.

### SUMMARY OF THE INVENTION

A method and apparatus are described, in accordance with the described principles, which can be used for generating recommendations for media assets to be consumed. In response to use of a user interface, one or more user representations are selected and placed within zones. User profile data of users corresponding to such user representations is used as the basis of making recommendations from a recommendation server, where the media asset recommendations accommodate the preferences of the users selected. Media asset recommendations can be presented as pictures, video clips, poster art, text, and the like.

### DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system communicating media assets in accordance with an embodiment of the present disclosure;

FIG. 2 is a block diagram of an exemplary consumption device in accordance with an embodiment of the present disclosure;

FIG. 3 is a user interface that is used for generating media asset recommendations in accordance with an embodiment of the present disclosure;

FIG. 4 is a user interface that is used for generating media asset recommendations in accordance with an embodiment of the present disclosure;

FIG. 5 is a user interface that is used for generating media asset recommendations in accordance with an embodiment of the present disclosure;

FIG. 6 is a user interface that is used for generating media asset recommendations in accordance with an embodiment of the present disclosure;

FIG. 7 is a user interface that is used for generating media asset recommendations in accordance with an embodiment of the present disclosure;

FIG. 8 is a user interface that is used for generating media asset recommendations in accordance with an embodiment of the present disclosure; and

FIG. 9 displays a flow diagram of a method for generating media asset recommendations in response to the manipulation of a user interface in accordance with an embodiment of the present disclosure.

### DESCRIPTION OF THE PREFERRED EMBODIMENTS

For purposes of this specification, the term social publishing service is an internet based service where a user posts different types of media assets such as videos, audio, pictures, electronic messages, links to websites, a message text, and the like to the publishing service. These media assets are then provided to a user who is accessing the social publishing. Some social publishing services support the publishing of multiple types of media assets as well. External users can access these published media assets through a program such as a web browser, a client application written specifically for a social publishing service which access such a social publishing service directly. Examples of existing social publishing services include FACEBOOK, TWITTER, FLICKR, PINTREST, INSTAGRAM, TUMBLR, YOUTUBE, and the like.

Social publishing services can also receive media assets from other social publishing services. For example, a user can publish their photos from a first social publishing service to a second publishing service. The same user can also publish other types of media assets from other publishing services to the second publishing service. In addition, some publishing services are capable of having media assets reposted from other users. For example, a first user can publish a media asset received from a second user through a social publishing service where such an operation is called a reposting operation.

Media assets from a social publishing service can also be forwarded to a user where such media assets can be collected in a storage repository such as a digital locker implemented as a server.

The term specified party relates to a person or service that a user permissively agrees to receive media assets from. In one example, a user accepts an invitation from a specified party on a social networking service such as FACEBOOK where the social networking service will make available through a posting operation, forwarding operation, communicating operation, providing operation, and the like, media assets from the specified party to the user. Conversely, a user sends an invitation to the specified party on a social networking service, where the media assets published by the specified party will be forwarded to the user when the specified party accepts the invitation. In a second example, a user indicates through a social publishing service such as TWITTER that the user wants to follow the posts from a specified party. Other connections between a user and a specified party can be created in accordance with the disclosed principles.

Users can be known as being linked or connected when a first user and a second user are “FRIENDS” of each other through a social networking service, where the first and second users are listed on the same list of a third user, a first and second user are grouped together in the same category either implicitly or explicitly with each other's permission, a first and second user are grouped together in the same category either implicitly or explicitly by a third party, and the like.

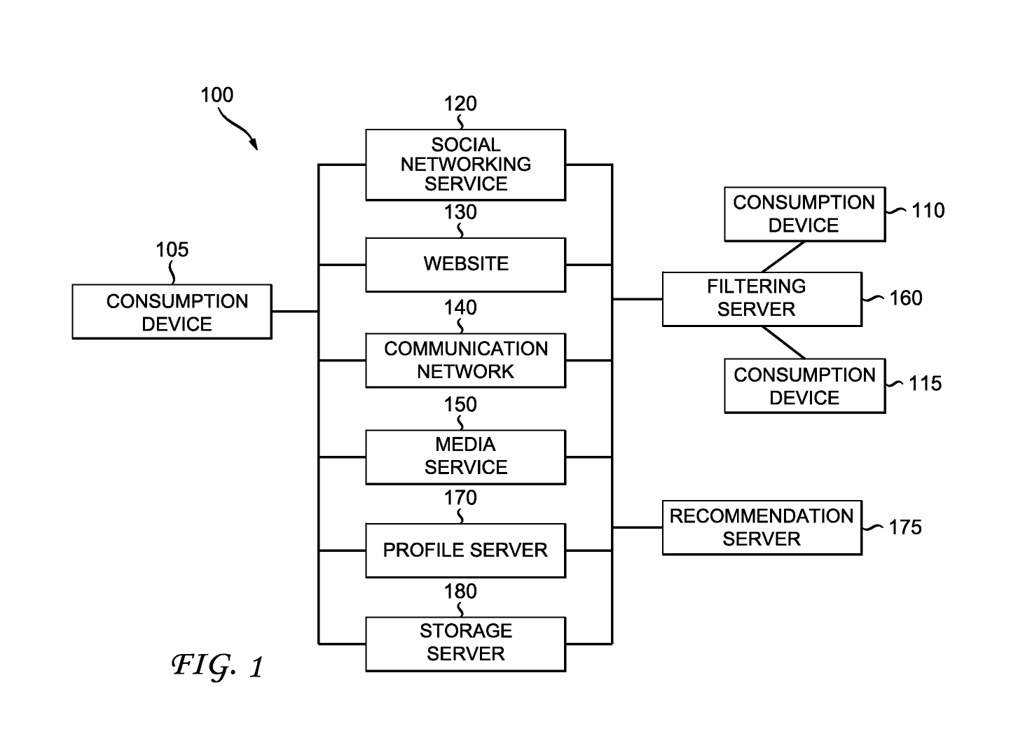

FIG. 1 is an exemplary embodiment of a system 100 in accordance with the present disclosure. Consumption device 105 represents a device such as a computer, set top box, tablet, television, phone, personal access device, gateway, and the like that is used to communicate an electronic communication to other devices such as consumption device 110 or consumption device 115.

The publishing of media assets between users operating consumption devices 105, 110, and 115 can take place through various social publishing services such as social network service 120. Examples of social networking services include, but are not limited to, FACEBOOK, GOOGLE+, MYSPACE, LINKEDIN, PINTREST, INSTAGRAM, TUMBLR and the like. The communication of media assets via social publishing services between users can also take place via a website 130 and/or a communication network 140 such as, and not limited to, a telephone connection, satellite, connection, cellular network, WI-FI Digital Subscriber Line (DSL), Internet communication, and the like. Media service provider 150 include, but are not limited to, NETFLIX, M-GO, AMAZON CLOUD SERVICE, ITUNES, PANDORA, FLICKR and the like can also be used to communicate media assets between users who use devices such as consumption devices 105, 110, and 115.

Filtering server 160 can filter the delivery of media assets between consumption devices 105, 110, and 120. That is, media assets are communicated from a social publishing service are first communicated to filter server 160 in order to determine if such media assets should be made available to different consumption devices. Filter server 160 can be set up to determine if the media asset is of a particular type, comes from a specified social publishing service, is published by a specified party using such a social publishing service, and to whom the media asset is being communicated to. Such information can come from the social publishing services themselves, a profile server 170 that contains profile information of different users, from users themselves, and the like. Filter server 160 based on the determinations listed above can communicate media assets to a user, prevent the communication of media assets to a user, forward media assets to a user, block the forwarding of media assets to a user, filter media assets, provide media assets, change access privileges to media assets, and the like.

In an optional embodiment, the operation of filtering server 160 can be performed within a social publishing service such a social networking service 120, website 130, communication network 140, media service provider 150, and the like. In another optional embodiment, the operation of filtering server 160 can also be performed within a consumption device 105, 110, 115, and the like.

Profile server 170 contains user profile data that indicates a user's preferences including the type of media assets the user wants to receive, the social publishing services used, the specified parties a user is connected with through such social publishing services, media asset filtering data, and the like. Such data can come from sources such as a consumption device 105, 110, 115, social networking service 120, website 130, communication network 140, media service provider 150, filtering service 160, a user, other social publishing service, and the like.

Profile server 170 can be implemented to keep track of the preferences and the specific media assets that a user has consumed in the past. Specifically, when a user consumes a media asset at the point of consumption device 105, 110, 115 which can be delivered from a source such as a media service provider 150, the user can indicate their respective like or dislike for a media asset by indicating a rating for such an asset. Profile service 170 can also be implemented to keep track of how a user actually consumes a media asset where, for example, a media asset which is stopped before such a media asset is completely played back could have a lower rating than a media asset that is completely consumed by a user watching such an asset to the end of the presentation. Other methodologies can be used to develop a user profile in accordance with the illustrative principles, where such user profile information can be developed for multiple users who use consumption devices 105, 110, 115, and the like.

Recommendation server 175 is a server that is implemented to give recommendations based on the user profile information that can come from sources such as consumption devices 105, 110, 115, social networking service 120, website 130, communication network 140, media service provider 150, filtering server 160, user profile server 170, storage server 180, and the like. Specifically, the recommendations that recommendation server 175 provides are for media assets that would be of interest to a user where the recommendations are made in view of the user profile data of a that user. The implementation of recommendation server 175 can make use of analytics software which data mines user profile data from user profile information and data listing the various media assets that are available for consumption through as consumption devices 105, 110, 115, social networking service 120, website 130, communication network 140, media service provider 150, storage server 180, and the like. Recommendation server 175 can also give recommendations for two or more users, when prompted, where the recommendations would be of interest to the two or more users if such people were to consume the same content. For example, media service provider 150 can offer a party viewing mode where two or more users, who are connected in a manner as described herein, can request to watch the same media asset at the same time. Recommendation server 175 could then recommend one or more media assets that would be of interest to the two or more users where such media assets would be available from the media service provider 150 during the party viewing mode. Recommendations can also be delivered in other settings too where two or more users are interested in accessing media assets at different times, but such users still want to know what media assets would be of interest to such users. Other approaches can apply to when two or more users would want to receive recommendations for media assets in accordance with the illustrative principles presented.

Storage server 180 contains media assets that are communicated from sources such as a consumption device 105, 110, 115, social networking service 120, website 130, communication network 140, media service provider 150, filtering service 160, a user, other social publishing service, and the like. Storage server 180 can also operate a storage locker for media assets.

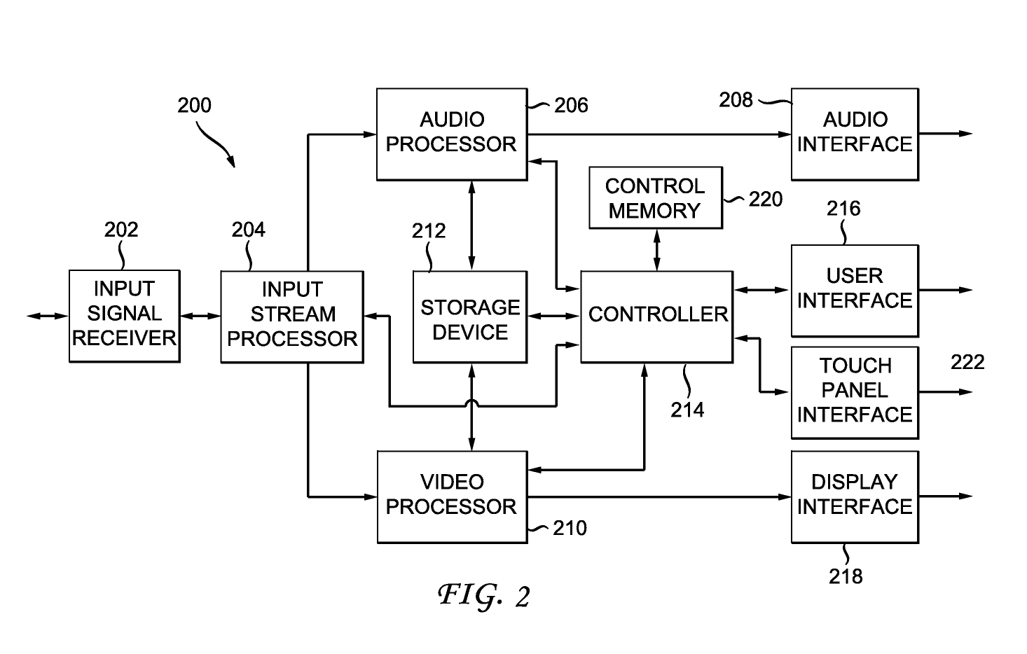

Turning now to FIG. 2, a block diagram of an embodiment of a consumption device 200 is shown. The device 200 shown can be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 can be one of several known receiver circuits used for receiving, demodulation, and decoding signals provided over one of the several possible networks including over the air, cable, satellite, Ethernet, fiber and phone line networks. The desired input signal can be selected and retrieved by the input signal receiver 202 based on user input provided through a control interface or touch panel interface 222. Touch panel interface 222 can include an interface for a touch screen device. Touch panel interface 222 can also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 can provide a digital signal to an audio output device or display device using a High-Definition Multimedia Interface (HDMI) cable or alternate audio interface such as via a Sony/Philips Digital Interconnect Format (SPDIF). The audio interface can also include amplifiers for driving one more sets of speakers. The audio processor 206 also performs any necessary conversion for the storage of the audio signals.

The video output from the input stream processor 204 is provided to a video processor 210. The video signal can be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 can be a hard disk drive, one or more large capacity integrated electronic memories, such as static RAM (SRAM), or dynamic RAM (DRAM), or can be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 can be an analog signal interface such as red-green-blue (RGB) or can be a digital interface such as HDMI. It is to be appreciated that the display interface 218 will generate the various screens for presenting the search results in a two dimensional form as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 can interface with a search engine for the searching of content and the creation and adjusting of the display of graphical objects representing such content which can be stored or to be delivered via storage server 180, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 can store instructions for controller 214. Control memory 220 can also store a database of elements, such as graphic elements containing content, various graphic elements used for generating a displayed user interface for display interface 218, and the like. Alternatively, the memory can store the graphic elements in identified or grouped memory locations and use an access or location table to identify the memory locations for the various portions of information related to the graphic elements. In addition, various graphic elements can be generated in response to computer instructions interpreted by controller 214 for output to display interface 218. Additional details related to the storage of the graphic elements will be described below. Further, the implementation of the control memory 220 can include several possible embodiments, such as a single memory device or, alternatively, more than one memory circuit communicatively connected or coupled together to form a shared or common memory. Still further, the memory can be included with other circuitry, such as portions of bus communications circuitry, in a larger circuit.

Optionally, controller 214 can be adapted to extract metadata from audio and video media by using audio processor 206 and video processor 210, respectively. That is, metadata that is contained in the video signal in the vertical blanking interval, auxiliary data fields associated with video, or in other areas in the video signal can be harvested by using the video processor 210 with controller 214 as to generate metadata that can be used for functions such as generating an electronic program guide, providing descriptive information about received video, supporting an auxiliary information service, and the like. Similarly, the audio processor 206 working with controller 214 can be adapted to recognize audio watermarks that can be in an audio signal. Such audio watermarks can then be used to perform some action such as the recognition of the audio signal identifying the source of an audio signal, or performing some other service. Furthermore, metadata to support the actions listed above can come from a network or other source.

Referring back to FIG. 1, profile server 170 can be implemented to keep track of a user's preferences including the type of media assets the user wants to receive, the social publishing services used, the specified parties a user is connected with through such social publishing services, where an example of such information for a user is shown in TABLE 1 in accordance with the presented principles.

TABLE 1

| | SOCIAL | | | | |
|---|---|---|---|---|---|
| SPECIFIED | PUBLISHING | PIC- | | | |
| PARTY | SERVICE | TURES | MESSAGES | AUDIO | VIDEO |
| FRIEND A | FACEBOOK | NO | YES | YES | YES |
| FRIEND A | TWITTER | NO | YES | NO | YES |
| FRIEND A | INSTAGRAM | YES | NO | NO | NO |
| FRIEND B | FACEBOOK | YES | NO | YES | YES |
| FRIEND B | TWITTER | NO | YES | NO | NO |
| FRIEND B | INSTAGRAM | NO | NO | NO | NO |
| FRIEND B | FLICKR | YES | NO | NO | NO |

The column for specified party represents the different people/entities that a user has a permissive relationship with. Social publishing service indicates a particular social publishing service that a user receives communications from in the form of media assets which are published from specified parties. The next four columns represent different types of media assets including pictures, messages, audio, and videos. The Yes or No indicate whether a user is supposed to receive a media asset type from a specified party which is communicated through a social publication service. Information that defines the specified party, media asset, media asset type, source of a published asset, social publishing service, and the like can come from commands that come from a social publishing service, metadata embedded within a media asset, metadata associated with a media asset, a separate stream of metadata, an XML commands, and the like. The described operations of permitting and preventing communications of media assets, as listed for TABLE 1 can be performed by consumption devices 105, 110, 115, social networking service 120, website 130, communications network 140, media service provider 150, filtering server 160, profile server 170, storage server 180, and the like, in accordance with the described principles.

Referring back to FIG. 1, recommendation server 175 can be implemented give media asset recommendations based on user profile information for a user or for a group of users. TABLE 2 provides an example of media assets recommendations for different users and groups of users in accordance with the presented principles.

TABLE 2

| | |
|---|---|
| USER(S) | MEDIA ASSET RECOMMENDATIONS |
| PRIMARY USER | PARANORMAL ACTIVITY, SAW |
| FRIEND A | PRETTY WOMAN, FRIED GREEN |
| | TOMATOES |
| FRIEND B | BULL DURHAM, TIN CUP, RAMBO III |
| PRIMARY USER AND | GHOST, LOST |
| FRIEND A | |
| PRIMARY USER AND | EXPENDIBLES, FRINGE, DOCTOR |
| FRIEND B | WHO |
| FRIEND A AND FRIEND B | LEAGUE OF THEIR OWN, THE |
| | CLIENT |
| PRIMARY USER, FRIEND | LOST, FRINGE, THE OTHERS |
| A, AND FRIEND B | |

The user column in TABLE 2 represents the different combinations of for which recommendations are being requested and media asset recommendations represent the specific commendations being made for a primary user and the respective friends who are also users. Note, groups of three or more users can also be implemented in accordance with the disclosed principles.

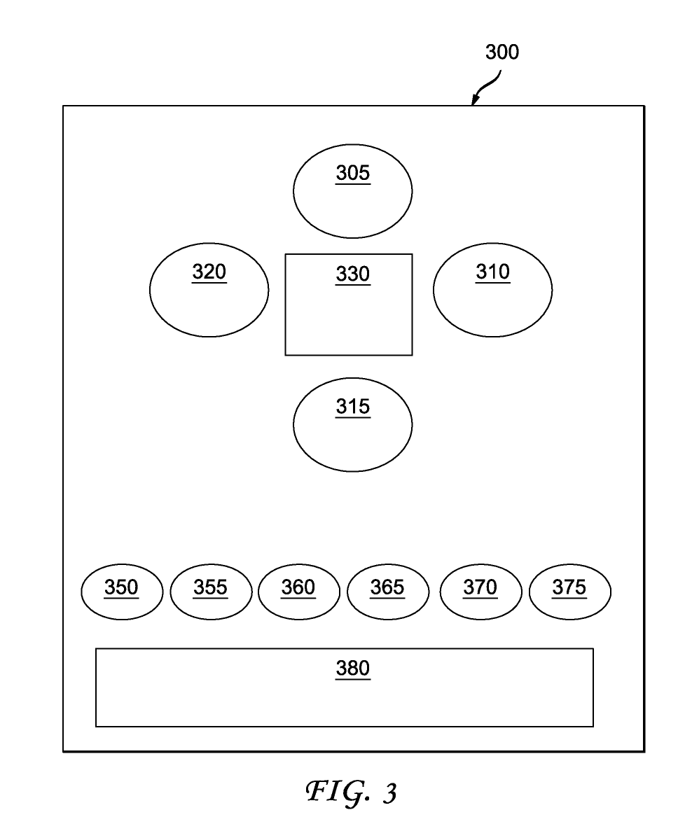

FIG. 3 is a representation of a user interface 300 that is used for generating recommendations in accordance with the presented principles. User interface 300 presents a number of zones 305, 310, 315, and 320 where a user can move any one of user representations 350, 355, 360, 365, 370, and 375 to these zones using an input device such as a mouse, touch input, keyboard, and other device capable of accepting user input. User representations 350, 355, 360, 365, 370, and 375 can be a picture of a user, an avatar of a user, text comporting to a user, a mixture of graphics and text of a user, and the like. Ideally, the user representations 350, 355, 360, 365, 370, and 375 each represent unique users with associated user profile information that can be accessed and stored in profile server 170. Recommendation zone 330 is interposed between zones 305, 310, 315, and 320 where instead of text being shown as media asset recommendations, a graphical element from a media asset such as a picture, video, poster art, and the like from the media asset is shown. Such graphical elements can come from recommendation server 175 directly, from a media service provider 150, and the like. Preferably, a short video clip of a recommended media asset is shown in recommendation zone 330 where multiple videos of corresponding recommended media assets can be cycled through and shown in recommendation zone 330 in response to user input. Textual results of recommended media assets can also be shown in results zone 380, as well. The recommendations shown in recommendation zone 330 and results area 380 will depend on which user representations 350, 355, 360, 365, 370, and 375 are placed within zones 305, 310, 315, and 320.

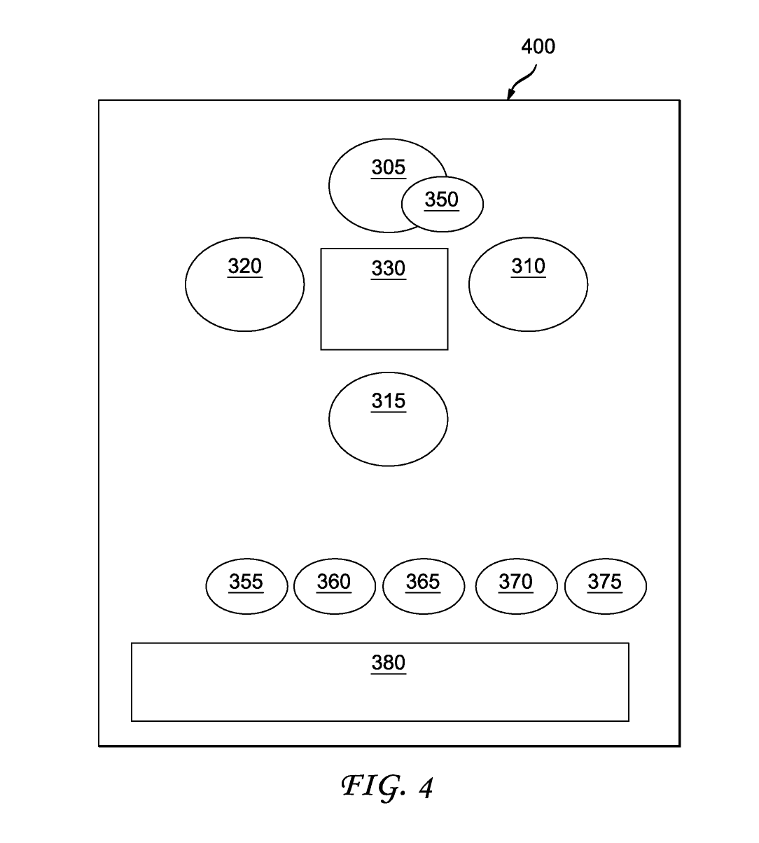

FIG. 4 is a representation of a user interface 400 that is used for generating recommendations in accordance with the presented principles. In the provided example, a user representation 350 comporting to a first user is placed within zone 305. In response to this action, recommendation server 175 can present data in recommendation zone 330 and in results 380 that comports to recommendations for the first user.

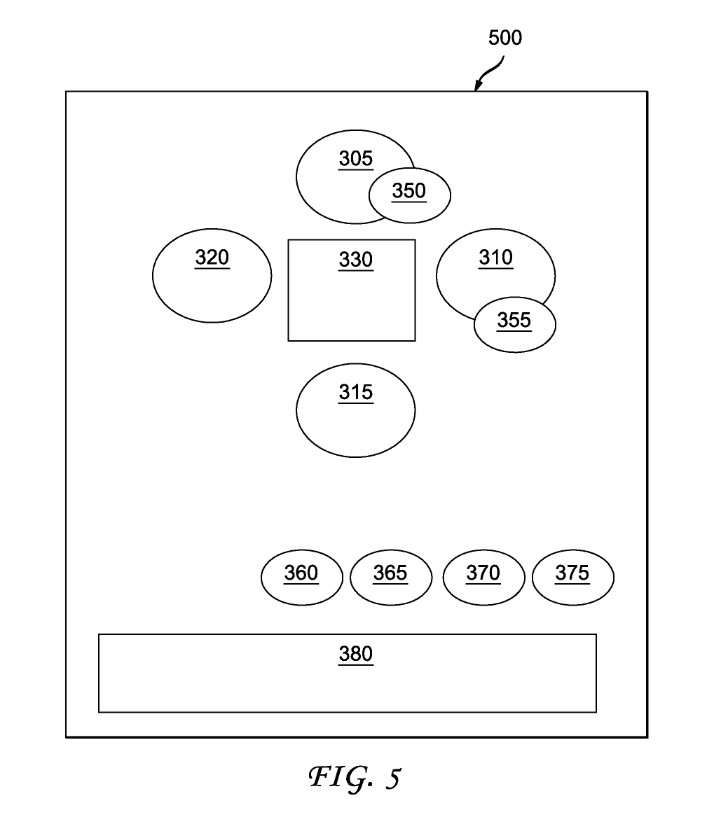

FIG. 5 is a representation of a user interface 500 that is used for generating recommendations in accordance with the presented principles. In the provided example, a user representation 350 comporting to a first user is placed within zone 350 while a user representation 355 for a second user is placed within a second zone 310. The outcome of such an action causes recommendation server 175 to generated recommendations to be presented in recommendation zone 330 and in results 380 that are recommendations for the first and second user.

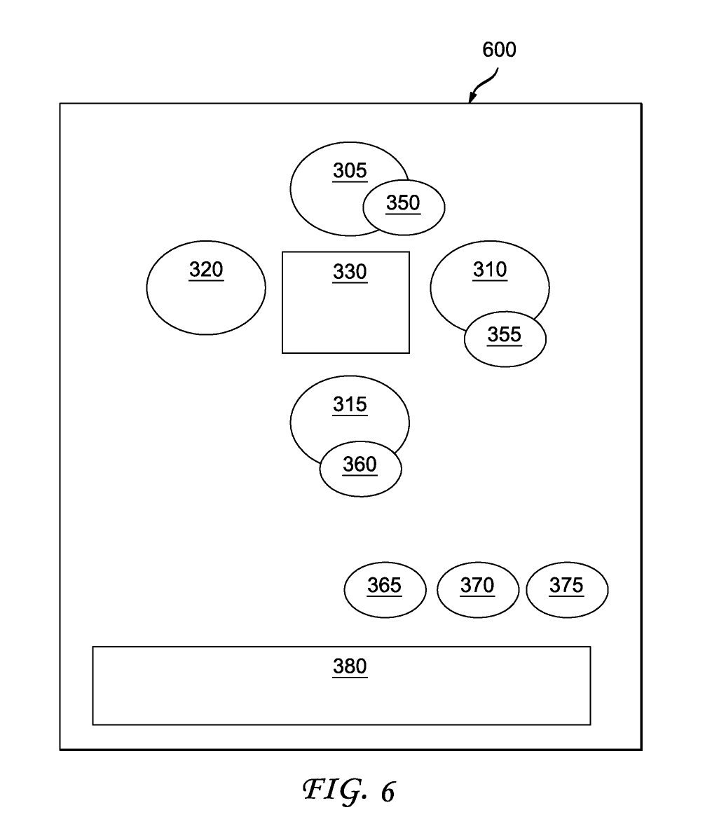

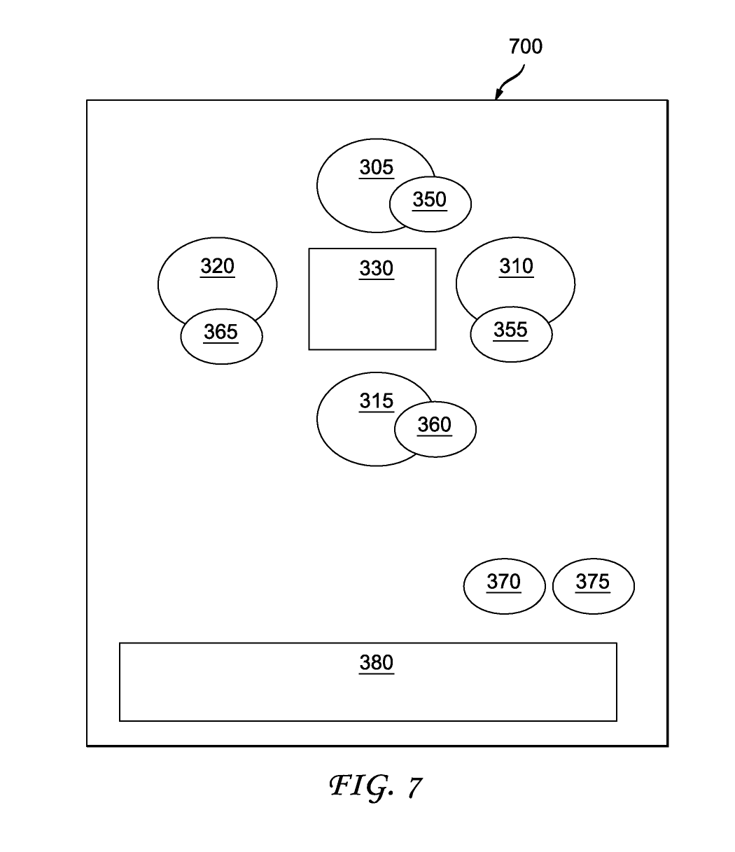

FIG. 6 presents a user interface 600 that has media asset recommendations being generated for a combination of three users. Specifically, user representations 350 of a first user, 355 of a second user, and 360 of third user are placed within zones 305, 310, and 315, respectively. The recommendations that are shown in recommendation zone 330 and in results 380 comport to recommendations for these three users. FIG. 7 presents a user interface 700 that has media asset recommendations being generated for a combination for four users as user representation 365 for a fourth user is being placed within zone 320.

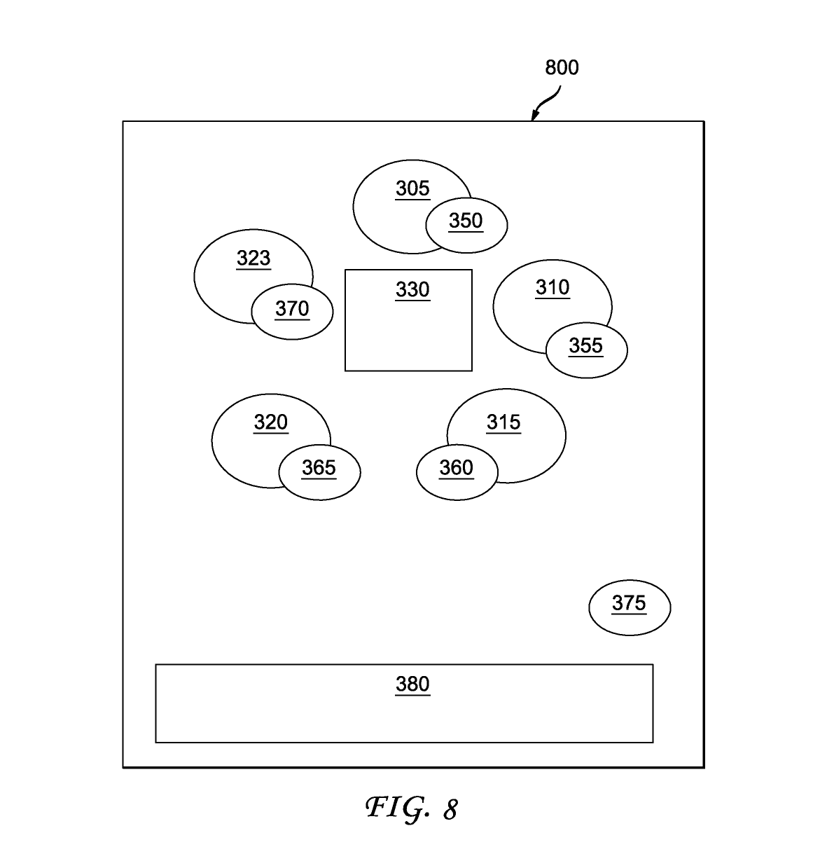

FIG. 8 presents a user interface 800 that has media asset recommendations being generated for a number of users. In this example, zones 305, 310, 315, and 320 previously existed as shown in FIGS. 3-7. When a user representation 370 comporting to a fifth user is placed by the preexisting zones, a new zone 323 is displayed for which user representation 370 can be placed. The results of the placement of user representation 370 within new zone 323 causes the generation of media asset recommendations for five users, where each user comports to user representations 350, 355, 360, 365, and 375 respectively. Note, although new zones can be added as needed, there can be a predetermined limit to the number of zones that can be added where such a limit is decided according to aesthetic reasons. Other versions of the disclosed user interfaces can be implemented in accordance with the presented principles.

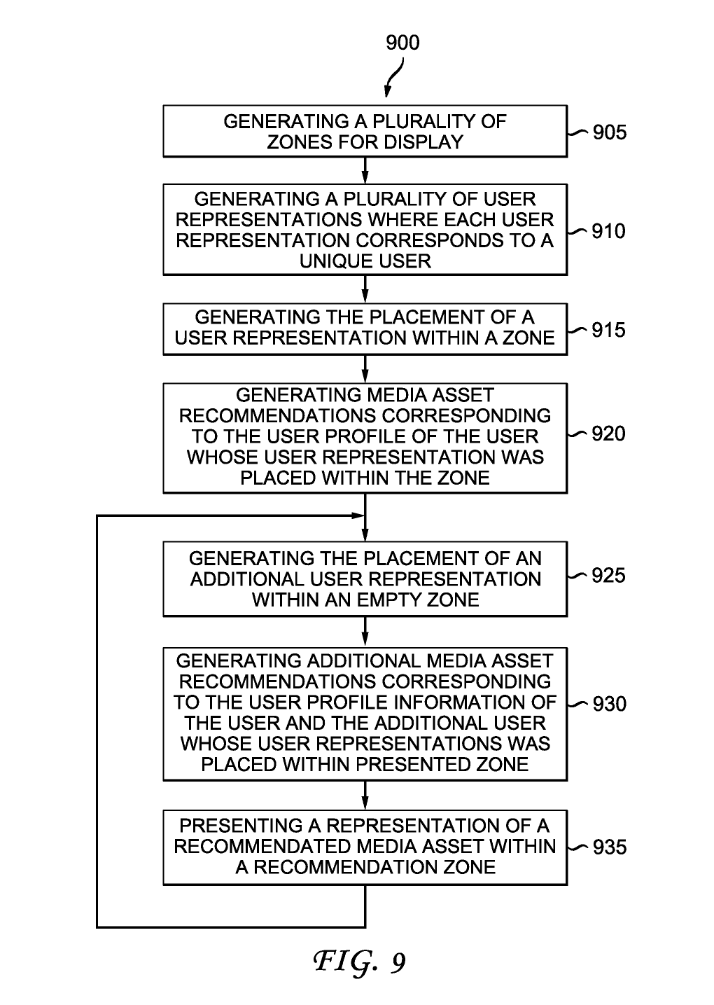

FIG. 9 is a representation of flow chart for a method 900 that is used for generating recommendations in accordance with the presented principles. The described steps can be implemented using a device 200, consumption devices 105, 110, 115, social networking service 120, website 130, communications network 140, media service provider 150, filtering server 160, profile server 170, recommendation server 175, storage server 180, and the like.

In step 905, a user interface is generated that displays a plurality of zones 305, 310, 315, and 320. Such zones, as shown in FIGS. 3-8, can be any shape. In step 910, a plurality of user representations 350, 355, 360, 365, 370, and 375 are shown in a user interface where each user representation corresponds to a unique user. Such user representations, as shown in FIGS. 3-8, can be of any shape.

In step 915, in response to user input by the manipulation of a user interface, a user representation such as 350, 355, 360, 370, and 375 is placed within a zone such as 305, 310, 315, and 320. The result of the placement of a selected user representation within a selected zone is that user profile server 170 presents user profile data to recommendation server 175, where the data corresponds to the user to whom such a representation corresponds. Recommendation server 175, in step 920, then performs a lookup or other processing technique and ends up recommending one or more media assets that would be of interest to the user using the user profile data. The media asset recommendations can be presented in a recommendation zone 330 as videos, pictures, and poster art and as text in results area 380.

In step 925, in response to user input by the manipulation of a user interface, an additional user representation such as 350, 355, 360, 370, and 375 is placed within an empty zone such as 305, 310, 315, and 320 and is displayed. The additional user representation comports to a second user. In step 930, the user profile data comporting to the first user and second user can be accessed from profile server 170 and recommendation server 175 can be accessed using the user profile data to generate additional media asset recommendations for the two users. The additional media asset recommendations can then be presented in recommendation zone 330 and in results area 380 during step 935. Note, steps 925 930, 935 can be repeated to accommodate more than two users and corresponding media asset recommendations.

It should be understood that the elements shown in the figures can be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. It is noted that modifications and variations can be made by persons skilled in the art in light of the above teachings.

1. A method for generating recommendations comprising:
generating a signal for displaying a plurality of zones (905) and a plurality of user representations (910); and
generating at least one recommendation for a media asset (920) when a user representation from said plurality of user representation is placed in a zone from said plurality of zones (915).

2. The method of claim 1 wherein said user representation corresponds to a first user and said at least one recommendation is generated from user profile data corresponding to said first user.

3. The method of claim 1 additionally comprising the step of:
generating at least one additional recommendation for a media asset when a second user representation from said plurality of user representations is placed in a second zone from said plurality of zones.

4. The method of claim 3 wherein:
said user representation corresponds to a first user;
said second user representation corresponds to a second user; and
said at least one additional recommendation is generated from user profile data corresponding to said first and second user.

5. The method of claim 4 wherein:
said first user and second users are different; and
said first zone and second zones are different.

6. The method of claim 1 additionally comprising the step of:
generating at least one additional recommendation for a media asset when at least two user representations from said plurality of user representations are each placed in a respective zone from said plurality of zones.

7. The method of claim 6 wherein
said user representation and at least two user representations correspond to different users; and
said at least one additional recommendations is generated from user profile data corresponding to said different users.

8. The method of claim 6 wherein said at least one recommendation changes when an additional user representation from said plurality of user representations is placed within an empty zone from said plurality of zones.

9. The method of claim 6 comprising the additional steps of:
generating a new zone which is added to said plurality of zones when an additional user representation from said plurality of user representations is placed close to said plurality of zones such that said new zone will accommodate the placement of said additional user representation.

10. The method of claim 9 wherein the number of additional new zones added to said plurality of zones is limited to a predetermined number.

11. The method of claim 1 wherein said at least one recommendation is displayed within a recommendation zone.

12. The method of claim 11 wherein said at least one recommendation that is displayed within said recommendation zone comports to at least one of: a picture from at least one media asset; a video from at least one media asset, and poster art from at least one media asset.

13. The method of claim 11 wherein said recommendation zone is interposed within said plurality of zones.

14. An apparatus for generating recommendations comprising:
a display processor (210) that generates a signal that displays a plurality of zones and a plurality of user representations;
a controller (214) that generates at least one recommendation for a media asset when a user representation from said plurality of user representation is placed in a zone from said plurality of zones.

15. The apparatus of claim 14 additionally comprising:
a storage device that stores user profile data corresponding to said first user and said user profile data is used by said processor to generate said at least one recommendation for a media asset.

16. The apparatus of claim 15 wherein said processor generates at least one additional recommendation for a media asset when a second user representation from said plurality of user representations is placed in a second zone from said plurality of zones.

17. The apparatus of claim 15 wherein:
said user representation corresponds to a first user;
said second user representation corresponds to a second user; and
said at least one additional recommendation is generated from user profile data corresponding to said first and second user that is stored in said storage device.

18. A user interface comprising:
a first displayed element representing plurality of zones (305, 310, 315, 320);
a second displayed element representing a plurality of user representation (350, 355, 360, 365, 370, 375); and
a third displayed element representing a recommendation zone (380) that displays at least one recommendation for a media asset when a user representation from said plurality of user representations (350, 355, 360, 365, 370, 375) is placed within a plurality of zones (305, 310, 315, 320) in response to user input.
